(19) United States
(12) Patent Application Publication
(10) Pub. No.: US 2014/0141181 A1
(43) Pub. Date: May 22, 2014

(54) PROCESS FOR FORMING RAINBOW AND HOLOGRAM IMAGES ON PAPERS

(71) Applicants: Munzer Makansi, Signal Mountain, TN (US); Andries Don Sebastian, Clemmons, NC (US)

(72) Inventors: Munzer Makansi, Signal Mountain, TN (US); Andries Don Sebastian, Clemmons, NC (US)

(21) Appl. No.: 14/063,969

(22) Filed: Oct. 25, 2013

Related U.S. Application Data
(60) Provisional application No. 61/796,769, filed on Nov. 19, 2012.

(51) Int. Cl. B44F 1/14; B65H 99/00

(52) U.S. Cl. CPC B44F 1/14; B65H 99/00
USPC 428/30; 493/339

(57) ABSTRACT

A process is provided for embossing a fibrous sheet with rainbow or hologram images, without the use of elevated temperatures, or the use of pre-wetting or softening agents.

### CROSS REFERENCE TO RELATED APPLICATIONS

This application claims priority from U.S. Provisional Application Ser. No. 61/796,769 filed Nov. 19, 2012, the contents of which are incorporated herein by reference.

### BACKGROUND OF THE INVENTION

1. Field of the Invention

This invention relates generally to a process for embossing sheet or board material with diffraction grating and/or hologram patterns, and to sheet or board material embossed with diffraction grating and/or hologram patterns. More particularly, the invention concerns a process wherein diffraction grating and/or hologram is embossed directly on a surface of the fibrous sheet of uncoated paper or board material without detrimentally affecting the flexibility and breathability of the sheet or board material, and to a sheet or board material embossed with diffraction grating and/or hologram patterns.

2. Description of the Prior Art

U.S. Pat. No. 5,882,770 to Makansi, one of the applicants of the present invention, discloses a fibrous sheet with an outer surface having fibrous elements which are embossed with a pattern of fine grooves that are substantially aligned from fibrous element to fibrous element. The pattern of fine grooves is embossed directly on the surface of the fibrous sheet and produces rainbow and/or hologram images on exposure to light that can be seen by the naked eye without using optical magnifiers.

U.S. Pat. No. 6,120,710, a continuation in part application to the above patent, also to Makansi, discloses a process for making a fibrous sheet that produces rainbow and /or hologram images disclosed in U.S. Pat. No. 5,882,770. This patent discloses that it is essential to apply softening agents to the outer surface of the fibrous sheet prior to, or during embossing. More specifically, it discloses the need to apply heat, as a softening agent, to the outer surface of fibrous sheets if these fibrous elements are comprised of thermoplastic organic polymers in order for the patterns of fine grooves to transfer from the surface of the embosser surface to the surface of the fibrous sheet structure and produce durable rainbow and/or holograms images on the surface of the sheet structure.

U.S. Pat. No. 7,229,681 to Boegli discloses a device for satinizing and embossing flat fibrous material surface and creating small teeth-like marks having different geometric shapes and protruding out from the surface of the flat materials. The surfaces and sides of these embossing teeth and/or portion of the tooth space bottom are provided with microstructures having diffraction grating properties. The different sizes, and orientations of these diffraction marks disrupt the alignments of the diffraction grooves between marks and prevents constructive interference reinforcement of the diffracted light rays which is required to produce coherent rainbow and/or hologram images of sufficiently large size to be visible to the naked eye without optical magnifier. The best that can be seen on a product successfully embossed with this device is a set of scattered microscopic light points or glitters originating from the separate micron size groove clusters. This patent fails to disclose the specific embossing process and the physical and chemical conditions of pressure, temperature, speed, contact time and softening agents required to emboss the claimed diffraction patterns on the surface of the flat material. This patent also fails to disclose or describe any specific physical example or demonstration or reduction to practice.

U.S. Pat. No. 8,105,677 to Kolivukunnas et at discloses an anti-counterfeiting product consisting of a layered structure comprising a paper or cardboard substrate having a surface layer, the surface layer being embossed first with diffractive microstructure areas located on bulges and a second diffractive microstructure areas located on recesses with the two areas being separated by height of 0.2 to 1.0 mm and connected together by doubly curved microstructure areas. As in U.S. Pat. No. 7,229,681 to Boegli, the presence of these bulges and recesses will disrupt the alignments of the diffraction grooves between bulges and recesses preventing constructive interference reinforcement of the diffracted light rays and preventing the formation of coherent rainbow and/or hologram images of sufficiently large size to be visible by the naked eye without optical magnifier. The best that can be seen on a product successfully embossed with this device is a set of scattered microscopic light points or glitters originating from the separate micro size groove clusters. This patent fails to disclose the specific embossing process and the physical and/or chemical conditions of pressure, temperature, speed, contact time and softening agents required to emboss such diffraction patterns on the surface of the flat material. Also the patent also fails to disclose or describe any specific physical example or demonstration or reduction to practice.

U.S. Pat. No. 7,628,887, to Jaaskelainen et al discloses a method for producing a security paper or board product, said security product comprising a paper or board security material, furthermore comprising optical diffractive structures carried by said security material and containing microstructures or nanostructures comprising at least a section that is detectable only by second or third level inspection tools such as laser pointer or bar code reader. These microstructures are not expected to produce rainbow or hologram image visible with naked eye without optical magnifiers. The patent also requires the use of embossing surface heated to elevated temperatures above 100° C., which creates macro size vapor blisters on the embossed surface of the paper, which may disrupt the alignment of grooves in the diffraction structures and prevents the formation of coherent rainbow or hologram images visible to the naked eye.

U.S. Pat. No. 5,862,750 to Giancarlo Dell'Olmo, discloses a method for impression of micro-engravings, which produce holograms, kinetic holograms or diffraction patterns directly on papers through embossing process. In this method paper is subjected to a pre-treatment step prior to embossing said micro-engravings to paper. The required pre-treatment is humidification step which gives to a paper a degree of humidity between 60% and 80% of relative humidity and then passing the sheet through the nip rolls of an embossing system running at elevated temperature and pressure on the paper within the range of 90-120° C. and 20-120 kg/mm² (28387-170316 PSI or 1.956×10⁵-1.735×10⁵ KPa) respectively.

In summary, with regards to generating diffraction or hologram images on papers and board products, the prior art discloses how to produce either (a) large rainbow and hologram images visible to the naked eye on impermeable plastic films or metal foils which are laminated or stitched to the surface of the paper or board but with accompanying detrimental effect on the breathability or tactile aesthetics of the paper or fabric, or (b) microscopic glitter points on the paper or board surface originating from separate clusters of small diffraction areas positioned at different topological levels of the surface, said surface level variations disrupt the continuity of the optical uniformity of the diffracted rays and prevent their constructive interference reinforcement to form large coherent rainbow and hologram images. Also the prior art processes comprise the application of softening agents such as heat or moisture prior to or during the embossing of diffraction patterns on papers.

### SUMMARY OF THE INVENTION

The present invention provides a method and apparatus for embossing sheet or board material with diffraction grating and/or hologram patterns that overcome the aforesaid and other problems with the prior art, without the need for a pre-treatment step with moisture or use of softening agents, and keeping the sheet or board temperature below about 100° C.

Moreover particularly, the invention in one aspect provides a process for embossing a flat uncoated non-thermoplastic fibrous sheet or board without the use elevated temperatures or the use of pre-wetting or softening agents that produces macroscopic size rainbow and hologram images visible to the naked eye, when exposed to light, without using optical magnifiers.

The process comprises the steps of bringing a hard-surface embosser, i.e., formed of a durable metal such as nickel or carbon steel, and capable of withstanding embossing pressures of up to 10⁵ N/cm in a continuous roll process or up to 10⁶ KP in a batch platen press process, and having a surface with a pattern of fine grooves thereon into direct contact with the surface of the fibrous sheet, the grooves being spaced apart uniformly by about 0.1 to 10 microns and being at least 0.1 micron deep, said grooves being oriented either in straight lines, or in curved lines or in circles, or in clusters of straight lines, or clusters of curved or angled line segments or clusters of a combination of straight and curved or angled lines, each such cluster being positioned next to or connected to an adjacent cluster so as to maximize constructive interference of and minimize destructive interference of their integrated diffracted light to produce large and coherent hologram images which are visible to the naked eye without the use of a magnifying glass upon exposure to light; and

imposing sufficient load on the embosser for a sufficient time, without softening the fibrous paper sheet with heat or moisture or treatment with a softening agent, all the while keeping the fibrous sheet temperature below about 100° C., to impress a pattern of the fine grooves into the surface of the sheet, the pattern of the fine grooves on individual fibrous elements of the sheet surface continuing to an adjacent fibrous element substantially in phase, with a distance between a last groove of one fibrous element and a first groove on a neighboring fibrous element being a multiple of groove width.

In one aspect of the invention the embosser grooves are spaced apart uniformly between 0.1 to 5 microns

In another aspect of the invention the fibrous elements comprise cellulosic polymers of natural plant origin selected from the group consisting of cotton, wood, leaves, bark, flax, papyrus, hemp, sisal and bamboo.

In yet another aspect of the invention the fibrous sheet comprises banknote currency paper, or cigarette paper or recycled paper.

In yet another aspect of the invention the fibrous sheet comprises a regenerated cellulosic material made by the Viscose Process, the Lyocell Process, The Modal Fiber Process or the Cupro Process.

In yet another aspect of the invention the fibrous sheet comprises rayon, viscose or an artificial silk.

In still yet another aspect of the invention the fibrous sheet comprises a synthetic man-made polymer, preferably a cellulose polymer.

In another aspect of the invention the fibrous sheet comprises a blend of two or more of the fibrous elements, and in which the fibrous elements preferably comprise synthetic man-made fiber.

The present invention also provides an embossed sheet or board made by the aforesaid process.

In still another aspect of the present invention provides a non-thermoplastic fibrous sheet having an outer surface with a pattern of fine grooves, the grooves being spaced apart uniformly by about 0.1 to 10 microns and being at least 0.1 micron deep, said grooves being oriented either in straight lines, or in curved lines or in circles, or in clusters of straight lines, or clusters of curved or angled line segments or clusters of a combination of straight and curved or angled lines, each such cluster being positioned next to or connected to an adjacent cluster so as to maximize constructive interference of and minimize destructive interference of their integrated diffracted light to produce large and coherent hologram images which are visible to the naked eye without the use of a magnifying glass upon exposure to light; wherein the pattern of the fine grooves on individual fibrous elements of the sheet surface continue to an adjacent fibrous element substantially in phase, with a distance between a last groove of one fibrous element and a first groove on a neighboring fibrous element being a multiple of groove width.

In one aspect the grooves are spaced apart uniformly between 0.1 to 5 microns.

In another aspect the fibrous elements comprise cellulosic polymers of natural plant origin selected from the group consisting of cotton, wood, leaves, bark, flax, papyrus, hemp, sisal and bamboo, or reprocessed cellulose material.

In still yet another aspect the fibrous sheet comprises banknote currency paper and/or cigarette paper, or recycled paper.

In yet another aspect the fibrous sheet comprises rayon, viscose or an artificial silk.

In a yet further aspect the fibrous sheet comprises a synthetic man-made polymer.

In another aspect the synthetic man-made polymer comprises a cellulose polymer.

In a still further aspect the fibrous sheet comprises a blend of two or more of the fibrous elements, and in which the fibrous elements preferably comprise synthetic man-made fiber.

### BRIEF DESCRIPTION OF THE DRAWINGS

The invention will be more readily understood by referring to the drawings wherein like numerals depict like parts, and wherein:

FIG. 1 is an exploded schematic view of a preferred assembly of items for batch-embossing fibrous paper sheet 10, the items including a hard embosser 11 (also called “stamper” or “shim”), a pressure multiplier 12 comprising a stiff and flat metal plate with smooth surfaces, said metal plate having area shape and dimensions selected to correspond with the area and dimensions of the rainbow or hologram images that will be embossed on the fibrous sheet, a supporting stiff and flat metal plate 12′ with smooth surfaces which is larger than the pressure multiplier plate, 12, carrier plates 13 ad 13′and platens 14 and 14′ of a platen press.

FIG. 2 is a schematic representation of a continuous embossing process similar to that in commercial use for embossing films, but also with appropriate controls, suitable for embossing, according with the present invention, fibrous sheets made from non-thermoplastic fibers (e.g. wood fibers in cellulosic papers) wherein fibrous sheet 21 is forwarded from feed roll 22 under idler roll 23 through a nip 29 formed by backup roll 25 and embossing roll 24 and over idler roll 26 to windup roll 27.

### DETAILED DESCRIPTION OF PREFERRED EMBODIMENTS

The meanings of the various terms used herein are as follows.

The term “Fibrous sheet” means a paper, board or the like products produced from non-thermoplastic fibers originating from natural sources such as wood and other cellulosic materials. As used herein “sheet” and “board” are used interchangeably.

“Fibrous element” means any fiber, filament, yarn, microfiber, nanofiber, fibril, or the like natural or synthetic polymer”.

“Fine grooves” means parallel grooves or segment of parallel grooves that are spaced apart uniformly by about 0.1 to 10 micrometers (microns) and are at least 0.01 micron deep. The presence of groups of such grooves on solid surface produces light diffraction patterns. Groups of straight parallel fine grooves also known as “diffraction gratings”, produce rainbow colors referred to hereafter as “rainbow images”. Clusters of parallel groove segments having straight, curved or wavy configurations, originating by hologram imaging process, reproduce the original images in the form of hologram images.

Quality rating of a hologram or a rainbow image refers to a number on a subjective scale from 0 to 10 which describes the combined effects of visual appearance of the embossed image clarity and its color brightness intensity with 0 representing no visible rainbow or hologram image or color, 5 representing clearly visible but colorless image and 10 representing the best looking image with bright hologram colors when the embossed rainbow or hologram image is viewed under bright sunlight or incandescent light.

The present invention in one aspect provides a fibrous sheet having patterns of fine grooves on the surface of the sheet. The patterns of grooves produce rainbow or hologram images that are visible at their best to the naked eye when the sheet surface is viewed at an angle to incident sunlight or incandescent light. The patterns of fine grooves or cluster of groove segments embossed on the individual fibrous elements of the surface of the fibrous sheet continue in phase to the neighboring fibrous elements substantially in phase such that the distance between the last groove on one fibrous element and the first groove on the neighboring fibrous element is a multiple (i.g. integer) of the groove width. Distinct coherent rainbow or hologram images with good colors, clarity and resolution are thereby produced.

The invention in another aspect provides a process for preparing fibrous sheets that produce rainbow or hologram images without detrimentally affecting desirable attributes inherent in the fibrous sheet (e.g. breathability, flexibility, tactile aesthetics). In accordance with the process of the invention, a flat sheet of fibrous elements is not softened, or pretreated with heat, water or chemicals or coated with a special layer on its surface and is not deformed topologically (e.g. with wrinkles, protrusions or depressions) prior or during embossing; and the surface of the flat sheet is brought into contact with the surface of hard embosser having a pattern of fine grooves on the surface; pressure is applied to the embosser to cause the groove pattern to be embossed into the surface of the fibrous elements on the surface of the flat sheet. Typically, the pressure is applied by the plates of the platen press or a pair of cooperating cylindrical rolls. The pressure is applied to the sheet for a time sufficient to emboss the embosser groove patterns onto the surface of the outermost fibrous elements of the fibrous sheet.

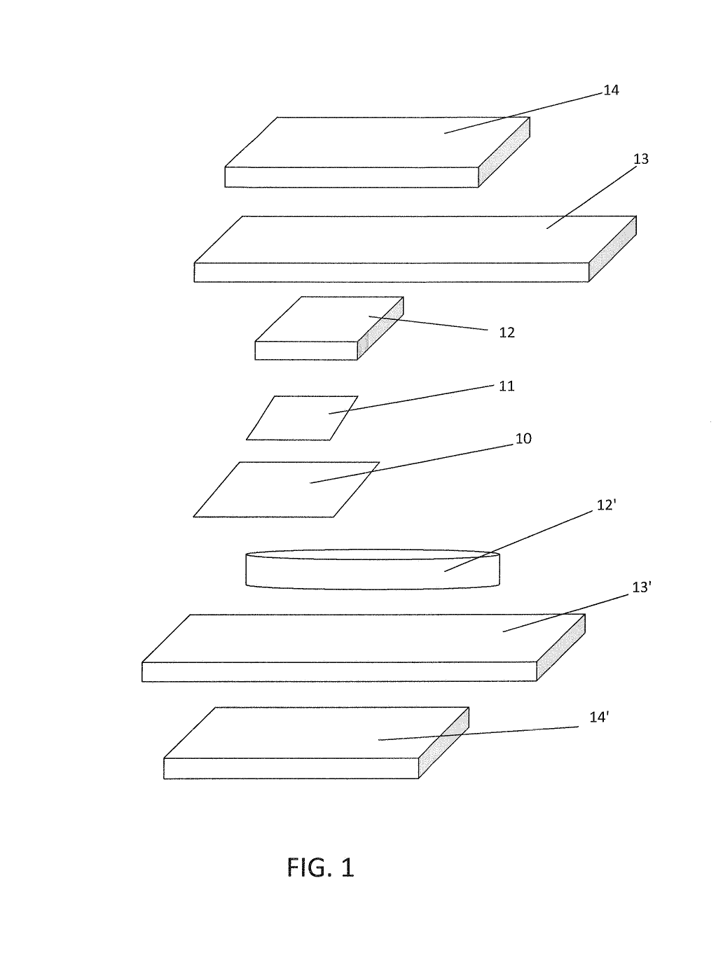

The accurate transfer of the groove pattern to the fibrous sheet can be accomplished conveniently with a platen press, as illustrated in FIG. 1. In accordance with this method, a composite sandwich is formed from a fibrous sheet 10 and an embossing stamper 11 in the center of the sandwich, a flat and stiff non-deformable supporting block 12′ at the bottom and a flat and stiff, non-deformable sheet 12 (referred to as pressure multiplier) at the top of the sandwich. The sandwich is then loaded between transporter plates 13 and 13′ and the composite system of sandwich and transporters is carried and placed between platens 14 and 14′. Pressure force is then applied for a predetermined time, after which the transporters and sandwich are removed from the press and the embossed paper sheet structure is separated from the stamper. Under these conditions the specific embossing pressure applied on the paper sheet structure can be calculated by dividing the pressure force transmitted to the platens of the press by the area of the pressure multiplier 12 of FIG. 1.

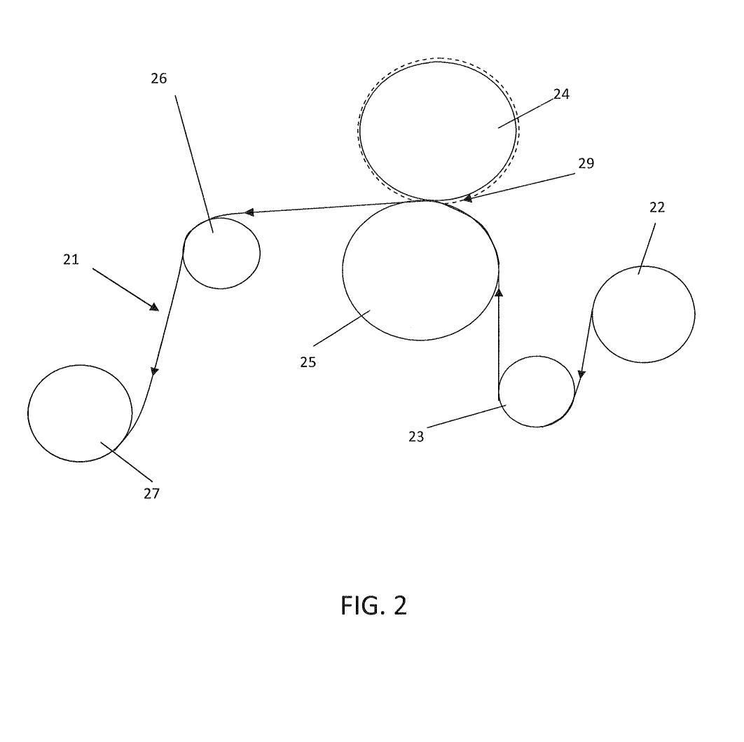

As an alternative to the batch or step wise process and equipment described above with regard to FIG. 1, the process of the invention also can be performed in a continuous manner with roll embossing equipment, as illustrated in FIG. 2. The same type of equipment, modified for higher embossing pressures, is also suitable for embossing sheets, papers, boards and other fibrous sheet structures made of cellulosic fibers. The equipment of FIG. 2 is more suitable for high production rates on commercial scale. As illustrated in FIG. 2, a sheet of paper 21 is advanced from a supply roll 22 under idler roll 23 through a nip 29 formed by back-up roll 25 and heated metallic embossing roll 24, and then the embossed sheet passes over idler roll 26 to wind-up roll 27.

The optimum embossing conditions for a particular type of paper, board or sheet can be determined through a simple series of short tests at different pressures and embossing times, in the particular equipment that is to be used. The optimum embossing conditions are those that provide clearly visible rainbow or holographic images with bright colors and without sacrificing the desirable properties of paper breathability, flexibility and tactile aesthetics. Such a series of tests run with roll embossing equipment on white cigarette and printer papers of examples 1, 3, 8, 9, 12 and 13 below showed that optimum embossing conditions require a temperature of less than 100° C., applying relatively high pressures, avoiding pretreatment with heat or moisture as softening agents, relatively short embossing time or high speed and good quality embossing Shims with narrow groove spacing.

As noted above, breathability, flexibility and tactile aesthetic properties of the fibrous sheet are substantially unaffected when a pattern of fine grooves is embossed on the surface of the fibrous sheet in accordance with the process of the invention. Some flattening of the embossed surface of the fibrous elements and some reduction of sheet thickness usually accompany the embossing, but negligible bonding occurs at fibrous elements cross-over points, beyond that which already exists in the sheet.

In applying a fine groove embossing pattern to a fibrous sheet according to the invention, the relative direction of the grooves and the filament in the sheet has little effect on the resulting images. Substantially the same effect is obtained if the fine grooves are parallel, perpendicular or at an angle to the filament axis. Also the fine groove patterns can be embossed on fibrous sheets of different colors, which contain conventional dyes, pigments or printed surface decoration, thereby adding dynamic colors and holographic images to the visual aesthetics to such sheets.

The rainbow and holographic images produced by the embossed pattern of fine grooves are best seen under bright sunlight or bright incandescent lights. Accordingly, embossed sheets and papers of the invention are particularly suited for outdoor end uses, on stage, or in any other well lighted environment. They are also particularly suited for security protection and anti-counterfeiting applications of logos, emblems and other applications such as decorative papers for use in retail, commercial or industrial packaging and various stationary items.

### EXAMPLES

The following examples illustrate the invention with the embossing of fine groove patterns on the surface of various sheets and papers to produce rainbow or hologram images. Some of these examples employed an assembly of the type depicted in FIG. 1 and some other examples employed an assembly of the type depicted in FIG. 2.

### Example 1

In this example white color papers were embossed using continuous roll equipment assembly of the type depicted in FIG. 2 whereby the embossing roll 24 has a length of 25 cm and a diameter of 25 cm with a surface made of stainless steel and is engraved with a “crystal” pattern of fine grooves having groove spacing of 5-6 micrometers apart and groove depth of 1-2 micrometers. This example is one of a series of several comparative tests in which the embossing roll temperature was high, i.e., above 113° C., but the roll speed was kept constant at 3 m/min and no wetting of the paper with water or any other pretreatment agents was used. The paper used was a glossy paper roll 7.6 cm wide and 12.7×10⁻³ cm thick. Embossing roll temperature was set at 204 C and the pressure, calculated based on the width of the paper, was 11.7×10³ N/cm (Newton/centimeter). Examination of the embossed paper surface under direct sunlight, and also under incandescent light, showed no visible pattern image nor visible colors on the embossed paper surface. Consequently the hologram quality rating was judged to be zero. However, it was observed that the embossed surface became covered with blister-like deformations. While not wishing to be bound by theory, these deformations are theorized to be caused by the internal evaporation of water molecules, normally present inside the cellulosic paper fibers, which are in equilibrium concentration with the existing ambient air humidity. Upon passing of the paper through the heated and pressurized nip 29 of FIG. 2 formed between the heated embossing roll 24 and the heated back-up roll 25 of FIG. 2 the paper is simultaneously heated to ˜204° C. and internally pressurized to 11.7×10³ N/cm. Upon exiting the nip 29 of FIG. 2 the paper internal pressure is released allowing the compressed water molecules inside the paper to boil and form internal and surface bubbles which, upon cooling to room temperature, collapse to form blister-like surface deformations. The presence of such topological surface deformation destroys the alignments of the fine grooves that might have been embossed in the nip on the pressurized paper surface which, in turn, prevents the formation of rainbow or hologram images on the paper surface.

### Example 2

The process of Example 1 was repeated except that the paper used was an assortment of five different cigarette paper rolls differing in thickness from 3.8×10⁻³ cm to 5.1×10⁻³ cm and having widths ranging from 2.5 cm to 6.4 cm. These papers were embossed at temperatures ranging from 113° C. to 171° C. and pressures ranging from 28×10³ N/cm to 70×10³ N/cm. As in Example 1 the embossed surfaces of each and all of these papers was deformed with blister-like patterns and the hologram quality rating was judged to be zero for all of them.

### Example 3

The process of Example 1 was repeated except that the embossing temperature was at room temperature of 27° C. and the embossing pressure was 35×10³ N/cm. Examination of the embossed paper, on the day of embossing, showed the presence of a faint colorless crystal pattern on the still smooth embossed surface with no blister-like distortions. This indicates that the grooves of the hologram crystal pattern have been successfully embossed from the embossing roll to the paper surface without distorting the paper surface smoothness. Examination of the embossed paper 15 days later showed that the embossed crystal pattern remained barely visible and colorless with a hologram quality rating of ˜1. This suggests that the embossing conditions of pressure and/or groove spacing used in this demonstration are not good enough.

### Example 4

The process of Example 3 was repeated except that embossing pressure was doubled to 70×10³ N/cm. The results were similar to the results of example 3.

### Example 5

The process of Example 3 was repeated except that the paper was wetted with water before embossing. The results were similar to the results of example 3.

### Example 6

The process of Example 3 was repeated to demonstrate paper embossing reproducibility. The results were similar to the results of example 3 confirming process reproducibility.

### Example 7

The process of Example 3 was repeated except that the paper was a cigarette paper and the embossing pressure was 52×10³ N/cm. The results were similar to the results of Example 3.

### Example 8

The process of Example 7 was repeated except that the embossing temperature was 27° C. and the embossing pressure was 104×10³ N/cm. The embossed crystal pattern on the cigarette paper was colorless with better visibility at a hologram quality rating of ˜2 when examined on the embossing day. However the pattern visibility and hologram quality deteriorated to a rating of zero when examined 15 days later.

### Example 9

The process of Example 8 was repeated except that the paper was wetted with water before embossing. The embossed crystal pattern on the cigarette paper was colorless with an inferior visibility at a hologram quality rating of ˜1 when examined on the embossing day. However the pattern visibility and hologram quality deteriorated to a rating of zero when examined 15 days later. This suggests that the presence of water in the paper distorted the paper surface which prevented a better hologram visibility rating.

### Example 10

The process of Example 8 was repeated except that the embossing temperature was higher at 82° C., compared with 27° C. in Example 8 but it was still below 100° C. The embossed crystal pattern on the cigarette paper was colorless with visibility at a hologram quality rating of ˜2, similar to Example 8, when examined on the embossing day. However, as in Example 8, the pattern visibility and hologram quality deteriorated to a rating of zero when examined 15 days later.

### Example 11

In this example the effect of embossing speed on hologram quality rating was investigated using the same embossing shim pattern as in the above examples. The paper used was a cigarette paper with a thickness of 6.4×10⁻³ cm and a width of 10.2 cm. The embossing temperature was 38° C. and the pressure was 26×10³ N/cm. A series of 7 runs was made at different embossing speeds starting from 3 m/min. to 90 m/min. The resulting hologram quality ratings on the day of embossing were 2 for speeds between 3 and 10 m/min and 1 for speeds between 30 and 90 m/min. These ratings dropped to zero when these samples were examined 15 days later.

This example, along with the previous example, shows that the dimensions of the crystal groove pattern that we used in these sets of examples were not close enough together to provide adequate number of diffraction light rays which interfere and reinforce one another upon arriving at the observer eye. Under these conditions faint and unstable pattern images were formed. These examples also showed that embossing the papers at temperatures above 100° C. damages the paper surface and prevents the formation of visible embossed holograms. It also indicates that wetting the paper with water prior to embossing at pressures at or above 104×10³ N/cm produces embossed pattern images with inferior quality rating than non-wetted paper.

### Example 12

The process of Example 1 was repeated except that the embossing material was a 3.8 cm wide×20.3 cm long sheet of thin nickel shim having a “quarter inch square” pattern formed by fine surface grooves spaced apart by about one micrometer. This is in contrast with the 5 micron spaced grooves engraved on the surface of the embossing roll used in Example 1. The embossing shim of this example was placed over a paper strip 5.1 cm wide×20.5 cm long with the grooved surface facing the paper surface. The resulting two layered structure was then hand fed into the nip 29 of the machine of FIG. 2 while it is running at specified sets of conditions. The embossed sandwich-like two layered structure was then collected from the downstream end of the nip 29 and the embossed paper was separated from the metal shim and examined visually to determine the resulting hologram quality rating of the embossed paper.

In this example a series of nine runs were conducted to demonstrate the effect of embossing pressure on the hologram quality ratings using these fixed conditions: The paper was a white cigarette paper 4.6×10⁻³ cm thick and 5.1 cm wide, the embossing roll temperature was 38° C. and the roll speed was 60 m/min. The results show that, at the pressures used in the range of 11.7×10¹ N/cm to 10.5×10⁴ N/cm calculated based on the width of the embossing shim, good quality holograms were obtained of the embossed quarter inch square pattern image on the paper surface with bright colors and image clarity. The combined quality rating of the color intensity and image clarity increased steadily from 5 (barely visible color) with a pressure of 11.7×10¹ N/cm to a quality rating of 9 (very good) with a pressure of 7.0×10⁴ N/cm. The embossed hologram quality rating was increased further to 9.5 (excellent) when the pressure was increased further to 10.5×10⁴ N/cm. These data also show that the hologram quality rating increased almost linearly with the logarithm of the pressure. In contrast with the embossed holograms of Examples 1 to Example 11 which were unstable and became invisible over 15 days of aging, the holograms of Example 12 are stable and retained their high quality ratings for more than a year.

### Example 13

The process of Example 12 was repeated except that the paper used was a white printer paper 7.5 cm×10⁻³ cm thick and a series of 8 experiments were conducted using embossing pressures in the range of 2.3×10³ N/cm to 69.9×10³ N/cm. The resulting hologram quality of the embossed holograms was rated at 9 (very good) for the middle 6 pressure range items of 4.6×10³ N/cm to 46.6×10³ N/cm. The outer lowest pressure item of 2.3×10³ N/cm and the outer highest pressure item 69.9×10³ N/cm were rated at 10 (excellent). This suggests that the process of embossing holograms on printer paper is less sensitive to the embossing pressure than the cigarette paper in example 12 where the embossed hologram quality rating started at 6.5 for an embossing pressure of 2.3×10³ N/cm and increased gradually to 9.0 for a pressure of 69.9×10³ N/cm. The higher hologram quality ratings of the printer paper are likely attributed to the fact that the printer paper is heavier and its fibrous surface is smoother than the cigarette paper.

### Example 14

The process of Example 13 was repeated at a pressure of 69.9×10³ N/cm except that the hologram shim pattern was different. It consists of “parallel bar” segments as compared with “quarter inch square” pattern in example 13. The resulting hologram quality was rated one step higher, at 10⁺ instead of 10.

### Example 15

The process of Example 14 was repeated at a pressure of 69.9×10³ N/cm and the use of a parallel bar pattern except that hologram embossing was demonstrated with several different kind of papers. The results are summarized in Table I below:

TABLE I
Effect of paper type on hologram quality rating

| | | Thickness | Hologram |
|---|---|---|---|
| Paper Type . . . | Color . . . | cm × 10⁻³ | quality rating |
| Cigarette paper | White | 5.0 | 10 |
| Transparent paper | white | 8.8 | 10⁺ |
| Manilla envelop paper | orange | 12.5 | 8 |
| Kraft wrapping paper | brown | 13.8 | 8 |
| Bank note paper (printed) | cream | 10.0 | 8 |
| Bank note paper (not printed) | cream | 10.0 | 10 |

### Example 16

The process of Example 14 was repeated at a pressure of 69.9×10³ N/cm and the use of a parallel bar pattern except that hologram embossing was demonstrated with papers having different colors. The results are summarized in Table I below:

TABLE II
Effect of paper color on hologram quality rating

| | | Thickness | Hologram |
|---|---|---|---|
| Paper Type . . . | Color . . . | cm × 10⁻³ | quality rating |
| Folder | cream | 22.5 | 7 |
| Folder | green | 12.5 | 7 |
| Folder | red | 12.5 | 10 |
| Folder | blue | 12.5 | 10⁺ |
| Folder | black | 12.5 | 10⁺⁺ |

### Example 17

In this example white colored 3.8 cm×10⁻³ cm thick cigarette papers were embossed using platen press equipment assembly of the type depicted in FIG. 1 whereby the press platens 14 and 14′ are 30.5 cm×30.5 cm squares steel plates 3.8 cm thick, the supporting block 12′ is circular stainless steel disk plate 1.0 cm thick and 10.2 cm in diameter. The relative area dimensions of the embossing components are selected to be as follows: the area of the pressure multiplier plate 12 is smaller than the area of the stamper 11, the surface area of the embossing stamper 11 is smaller than the surface area of the fibrous sheet 10 which is in contact with the surface of the supporting block 12′, the surface area of the supporting block 12′ is smaller than the areas of the each of the press platens 14 and 14′. Under this arrangement the pressure applied by the platens force on the embosser shim/fibrous structure interface is magnified and is calculated by dividing the platen press force by the area of the pressure multiplier 12. In this example several cigarette papers were embossed separately at the same temperature of 27 C, under the same pressure of 1.4×10⁵ KP (kilo Pascal) and for the same embossing time of 3 minutes using stampers having different groove patterns. The resulting hologram quality ratings were different for different patterns as Shown in Table III below:

TABLE III
Effect of Hologram shim pattern design on hologram quality rating

| Groove Pattern | Quality rating |
|---|---|
| “2 inch square” | 4 |
| “Herring bone” | 5 |
| “Rotating wheel” | 9 |

### Example 18

The process of Example 17 was repeated except that the papers were office folder papers 0.025 cm thick with different colors: violet, cream, yellow and black. The embossing shim pattern was “rotating wheel”, the temperature was 80° C., the pressure was 1.0×10⁵ KP and the embossing time was one minute. The resulting hologram quality ratings were 7 for all samples except the black paper which had a rating of 8.

### Example 19

The process of Example 17 was repeated except that the papers were US bank note currency papers previously printed with images of different colors in different areas of the surfaces. The embossing shim groove pattern was “herring bone”, the temperature was 80° C., the pressure was 1.4×10⁵ KP and the embossing time was 4 minutes. The resulting hologram quality rating was 5 on the white embossed areas and 8.5 on the black embossed area.

Various changes may be made without departing from the spirit and scope of the present invention. Therefore, the scope of the invention is not intended to be limited, except as indicated in the appended claims.

We claim:

1. A process for producing rainbow or hologram images on a non-thermoplastic fibrous sheet comprising the steps of bringing a hard embosser having a surface with a pattern of fine grooves thereon into direct contact with the surface of the fibrous sheet, the grooves being spaced apart uniformly by about 0.1 to 10 microns and being at least 0.1 micron deep, said grooves being oriented either in straight lines, or in curved lines or in circles, or in clusters of straight lines, or clusters of curved or angled line segments or clusters of a combination of straight and curved or angled lines, each such cluster being positioned next to or connected to an adjacent cluster so as to maximize constructive interference and minimize destructive interference of their integrated diffracted light to produce large and coherent hologram images which are visible to the naked eye without the use of a magnifying glass upon exposure to light; and
imposing sufficient load on the embosser for a sufficient time, without softening the fibrous paper sheet with heat or moisture or treatment with a softening agent while keeping the fibrous sheet temperature below about 100° C., to impress a pattern of the fine grooves into the surface of the sheet, the pattern of the fine grooves on individual fibrous elements of the sheet surface continuing to an adjacent fibrous element substantially in phase, with a distance between a last groove of one fibrous element and a first groove on a neighboring fibrous element being a multiple of groove width.

2. The process according to claim 1, wherein the embosser grooves are spaced apart uniformly between 0.1 to 5 microns.

3. The process according to claim 1, wherein the fibrous elements comprise cellulosic polymers of natural plant origin selected from the group consisting of cotton, wood, leaves, bark, flax, papyrus, hemp, sisal and bamboo, or regenerated cellulosic material made by the Viscose Process, the Lyocell Process, the Modal Fiber Process or the Cuprous Processes.

4. The process according to claim 1, wherein the fibrous sheet comprises banknote currency paper or cigarette paper or recycled paper.

5. The process according to claim 1, wherein the fibrous sheet comprises an artificial silk.

6. The process according to claim 1, wherein the fibrous sheet comprises a synthetic man-made polymer.

7. The process according to claim 6, wherein the synthetic man-made polymer comprises a cellulose polymer.

8. The process according to claim 1, wherein the fibrous sheet comprises a blend of two or more of the fibrous elements.

9. The process according to claim 8, wherein the fibrous element comprise synthetic man-made fiber.

10. A non-thermoplastic fibrous sheet having an outer surface with a pattern of fine grooves, the grooves being spaced apart uniformly by about 0.1 to 10 microns and being at least 0.1 micron deep, said grooves being oriented either in straight lines, or in curved lines or in circles, or in clusters of straight lines, or clusters of curved or angled line segments or clusters of a combination of straight and curved or angled lines, each such cluster being positioned next to or connected to an adjacent cluster so as to maximize constructive interference of and minimize destructive interference of their integrated diffracted light to produce large and coherent hologram images which are visible to the naked eye without the use of a magnifying glass upon exposure to light; wherein the pattern of the fine grooves on individual fibrous elements of the sheet surface continue to an adjacent fibrous element substantially in phase, with a distance between a last groove of one fibrous element and a first groove on a neighboring fibrous element being a multiple of groove width.

11. The fibrous sheet according to claim 10, wherein the grooves are spaced apart uniformly between 0.1 to 5 microns.

12. The fibrous sheet according to claim 10, wherein the fibrous elements comprise cellulosic polymers of natural plant origin selected from the group consisting of cotton, wood, leaves, bark, flax, papyrus, hemp, sisal and bamboo, or regenerated cellulosic material made by the Viscose Process, the Lyocell Process, the Modal Fiber Process, or the Cuprous Processes

13. The fibrous sheet according to claim 10, wherein the fibrous sheet comprises banknote currency paper or cigarette paper.

14. The fibrous sheet according to claim 10, wherein the paper fibrous sheet comprises recycled paper.

15. The fibrous sheet according to claim 10, wherein the fibrous sheet comprises an artificial silk.

16. The fibrous sheet according to claim 10, wherein the fibrous sheet comprises a synthetic man-made polymer.

17. The fibrous sheet according to claim 16, wherein the synthetic man-made polymer comprises a cellulose polymer.

18. The fibrous sheet according to claim 10, wherein the fibrous sheet comprises a blend of two or more of the fibrous elements.

19. The fibrous sheet according to claim 18, wherein the fibrous element comprise synthetic man-made fiber.
